(19) United States
(12) Patent Application Publication
(10) Pub. No.: US 2009/0195596 A1
(43) Pub. Date: Aug. 6, 2009

(54) Printing device

(76) Inventors: Teruhito Oka, Arida-gun (JP); Hideya Miyazaki, Iwade-shi (JP)

Correspondence Address: FULBRIGHT & JAWORSKI, LLP, 666 FIFTH AVE, NEW YORK, NY, 10103-3198, US

(21) Appl. No.: 12/321,617

(22) Filed: Jan. 23, 2009

(30) Foreign Application Priority Data
Jan. 23, 2008 (JP) 2008-012824
Feb. 13, 2008 (JP) 2008-031762

(51) Int. Cl. B41J 23/00

(52) U.S. Cl. 347/37

(57) ABSTRACT

A printing device includes a print head configured to discharge ink onto a recording medium while moving in a main scanning direction. The print head includes: a support face; a shock absorber; and a weight supported by the support face through the shock absorber.

### BACKGROUND OF THE INVENTION

1. Field of the Invention

The present invention relates to a printing device including: a print head for discharging ink onto a recording medium while moving in a main scanning direction; and a delivery mechanism for advancing the recording medium by a set amount in a sub-scanning direction orthogonal to the main scanning direction when the print head reached a moving end, wherein the print head moves in an opposite direction after the recording medium is advanced by the delivery mechanism, and especially to a technique for suppressing vibration of the print head.

2. Description of the Related Art

For a printing device having such a structure as described above, there can be mentioned those disclosed in JP8-276577A and JP2000-263870A. JP8-276577A discloses a technique in which, in order to suppress generation of vibration, a pair of print heads (ink-jet heads in the document) having the same mass are moved in opposite directions, to thereby cancel out reaction forces generated by reciprocating motion of the print heads.

JP2000-263870A discloses a technique in which, when a carriage mounting a print head (recording head in the document) thereon is moved in a main scanning direction, a medium delivering means including a delivery roller, a delivery belt and the like, for advancing a recording medium in a sub-scanning direction, is moved in an opposite direction to the moving direction of the cartridge at the same speed, to thereby suppress vibration.

In an ink-jet type printing device, a printing process period can be shortened by moving a print head at a high speed, and swiftly switching a moving direction of the print head at a moving end to restart moving. However, when the print head moving at a high speed is stopped and then moved in an opposite direction, printing is restarted by moving the print head before vibration acting on the print head attenuates. Due to this vibration, regions with uneven ink concentration appear on both end portions of the recording medium, leading to a poor quality in printed image. Accordingly, there can be mentioned techniques disclosed in JP8-276577A or JP2000-263870A. However, these techniques require complicated structures, and are poorly feasible because of their large size. It should be noted that the expression “both end portions” of the recording medium means portions corresponding to positions of the both ends of the path of the print head in terms of the moving direction (main scanning direction) of the print head. When printing is restarted without attenuating vibration of the print head, strip-shaped regions with uneven concentration appear in both end portions, extending in a longitudinal direction (sub-scanning direction).

With respect to a printing device which performs printing by simply reciprocating the print head, an analysis of vibration generation at the print head has revealed that there is a phenomenon in which end portions of the print head in terms of the sub-scanning direction vertically (upward and downward) vibrates, when the print head moving at a high speed is stopped and then restarted to move in an opposite direction. It is believed that the phenomenon includes the details that, when the print head moving at a high speed is brought to a sudden stop, kinetic energy of the print head tends to generate vibration, and when the print head starts to move at a high speed, kinetic energy of the print head tends to further generate vibration.

One factor for such a phenomenon of vibration in the print head may lie in a support structure using guide rails for supporting the print head, but an improvement of the support structure using the guide rails will require a complicated structure, and from this point of view, there is room for improvement.

The object of the present invention is to provide a reasonable structure of the printing device that suppresses vibration of the print head and performs printing with a high quality, even though the print head is actuated at a high speed.

### SUMMARY OF THE INVENTION

In one aspect of the present invention, there is provided a printing device including: a print head configured to discharge ink onto a recording medium while moving in a main scanning direction, which comprises: a support face; a shock absorber; and a weight supported by the support face through the shock absorber.

According to this structure, in the case where printing is performed at a high speed by restarting to move the print head before vibration of the print head attenuates, the print head moving in the main scanning direction is stopped and thus kinetic energy of the print head acts in a direction that may otherwise generate vertical vibration of the print head. However, the shock absorber flexibly deforms, and thus the weight can be displaced in the main scanning direction due to dynamic inertia, and in addition, the weight acts in a direction that holds down the print head. As a result, kinetic energy of the weight never acts in a direction that generates vibration. Moreover, since the weight tends to be displaced in the main scanning direction, vibration of the print head is suppressed. Likewise, when the print head is started to move at a high speed, kinetic energy acts in a direction that may otherwise generate vertical vibration of the print head. However, static inertia, or remaining dynamic inertia caused immediately before the stopping of the print head acts on the weight. Therefore, the shock absorber flexibly deforms, and thus the weight can be displaced in the main scanning direction with a delay. In addition, since the weight acts in a direction that holds down the print head, vibration of the print head is suppressed by the weight. As a result, there can be reasonably attained a printing device having a structure in which printing can be performed with a high quality by suppressing vibration of the print head, even when the print head is actuated at a high speed.

In the present invention, the print head may further includes an elevation suppressing member configured to suppress elevation of the weight while allowing a displacement of the weight in the main scanning direction on the support face. According to this configuration, even if the printing device is tilted to a large degree for installing the printing device or the like, the weight is never detached.

In the present invention, the print head may have a regulator configured to determine a displacement limit of the weight in the main scanning direction on the support face, which faces the weight in the main scanning direction. According to this configuration, even when the printing device is tilted to a large degree for installing the printing device or the like, the weight is brought into contact with the regulator, to thereby prevent the displacement of the weight above the limit.

In the present invention, the shock absorber may include a plurality of rods which are set on the support face in such a manner that a longitudinal direction of the rod is oriented in a sub-scanning direction orthogonal to the main scanning direction. According to this configuration, for example, as compared with a shock absorber in a sheet shape having the same size as that of the weight, the relative displacement between the print head and the weight is excellently preformed to thereby excellently suppress vibration, even under a circumstance in which vibration may otherwise be generated in the print head.

In another aspect of the present invention, there is provided a printing device including: a print head configured to discharge ink onto a recording medium while moving in a main scanning direction, which includes a vibration suppressor which is provided to the print head movably in the main scanning direction, and is configured to suppress vibration of the print head caused along with the movement of the print head.

According to this structure, in the case where printing is performed at high speed by restarting to move the print head before vibration of the print head attenuates, the print head moving in the main scanning direction is stopped and thus kinetic energy of the print head acts in a direction that may otherwise generate vertical vibration of the print head. However, since the vibration suppressor is allowed to be freely displaced relative to the print head due to dynamic inertia, even when vibration of the print head may otherwise be generated by impact, the vibration suppressor acts in a direction that suppresses vibration of the print head, to thereby suppress vibration. Likewise, when the print head in a resting state at the moving end is started to move at a high speed, kinetic energy acts on the print head in a direction that may otherwise generate vertical vibration of the print head. However, when the print head is in a resting state, static inertia acts on the vibration suppressor, or dynamic inertia caused immediately before the stopping of the print head remains in the vibration suppressor, and thus the vibration suppressor is allowed to be freely displaced relative to the print head. Therefore, even when vibration of the print head may otherwise be generated by impact, vibration suppressor acts in a direction that suppresses vibration of the print head, to thereby suppress vibration. As a result, there can be reasonably attained a printing device in which printing can be preformed with a high quality by suppressing vibration of the print head, even though the print head is actuated at a high speed.

In this aspect of the present invention, the vibration suppressor may be contained in one of a flexible bag member disposed on the print head and a space formed in the print head. According to this configuration, under a circumstance where the vibration suppressor is allowed to be freely displaced, it is possible to make a force act in a direction that suppresses vibration of the print head.

In this aspect of the present invention, the vibration suppressor may be formed of one of a granular body and a fluid body having a high viscosity. According to this configuration, by allowing free displacement of the granular body or the fluid body having a high viscosity relative to the print head, vibration is suppressed by the weight thereof.

### BRIEF DESCRIPTION OF THE DRAWINGS

FIG. 1 is a perspective view showing a main structure of a printing device.

FIG. 2 is a longitudinal sectional side view showing a main structure of a printing device.

FIG. 3 is a plan view showing an actuation system of a print head according to a first embodiment.

FIG. 4 is a perspective view showing a carriage of the print head according to the first embodiment.

FIG. 5 is a side view showing the carriage of the print head according to the first embodiment.

FIG. 6 is a perspective exploded view showing a support structure for a weight according to the first embodiment.

FIG. 7 is a longitudinal sectional side view showing the support structure for the weight according to the first embodiment.

FIG. 8 is a longitudinal sectional front view showing the support structure for the weight according to the first embodiment.

FIG. 9 is a plan view showing an actuation system of a print head according to a second embodiment.

FIG. 10 is a perspective view showing a carriage of the print head according to the second embodiment.

FIG. 11 is a side view showing the carriage of the print head according to the second embodiment.

Each of FIGS. 12A and 12B is a cross section showing a state of a vibration suppressor according to the second embodiment.

Each of FIGS. 13A and 13B is a cross section showing a state of a modified version of a vibration suppressor according to the second embodiment.

### DETAILED DESCRIPTION OF THE PREFERRED EMBODIMENT

### First Embodiment

Hereinbelow, a first embodiment of the present invention will be described with reference to drawings.

### <Overall Structure>

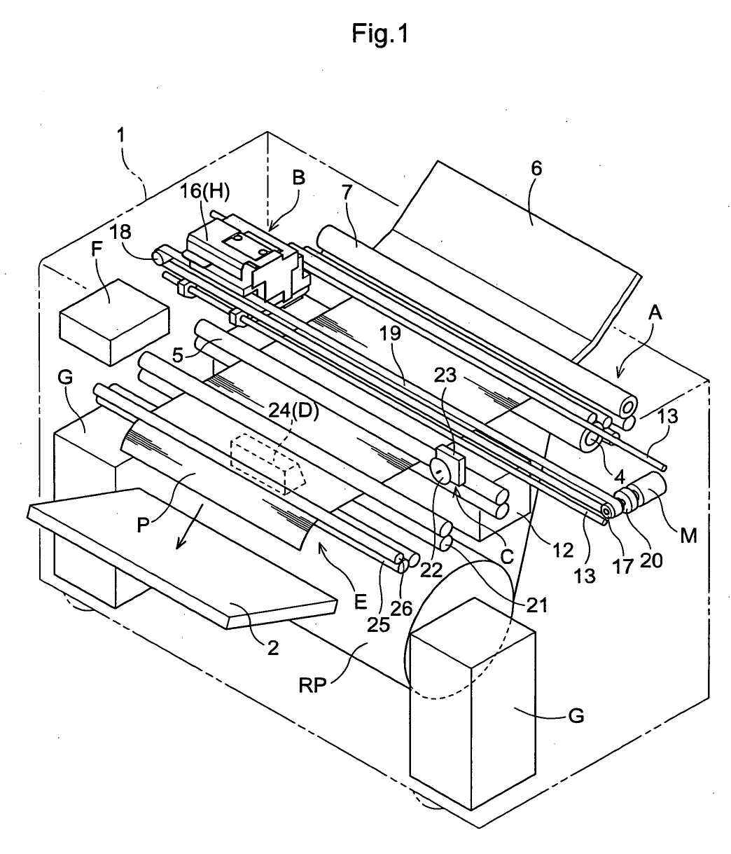

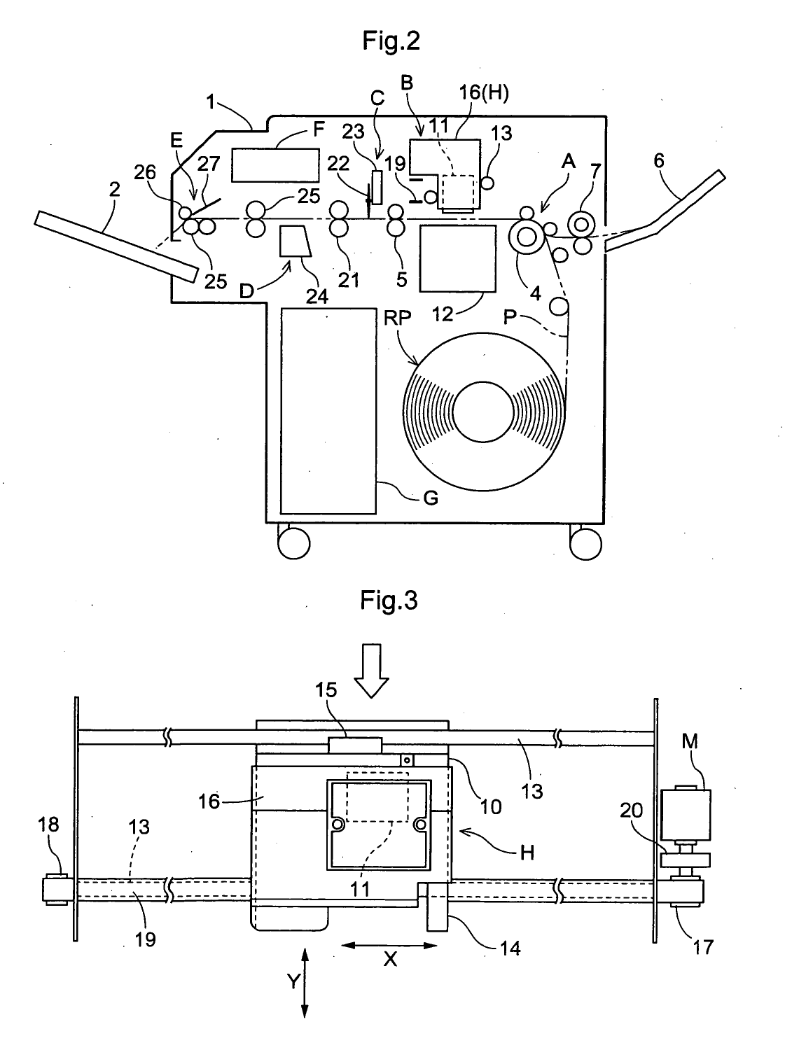

As shown in FIGS. 1 and 2, an ink-jet type printing device includes: a delivery system in which a printing paper P is drawn out from a roll of a printing paper RP as a recording medium, which is then supplied by a delivery mechanism A to a print part B, where printing of information is performed, and the printing paper P is advanced to a cutting part C, a backside print part D and a decurl part E in this order, and ejected on a paper catch tray 2 provided on an outside of a housing 1; and a control unit F and an ink reservoir G in the housing 1.

The delivery mechanism A has pressure bonding-type delivery rollers 4,5 disposed upstream and downstream in a delivery direction, respectively, of the print part B. Alternatively, the delivery mechanism A may be configured so that a cut paper placed in a manual paper feed tray 6 provided outside the housing 1 is fed by a pressure bonding-type supply roller 7 to thereby supply the cut paper to the print part B.

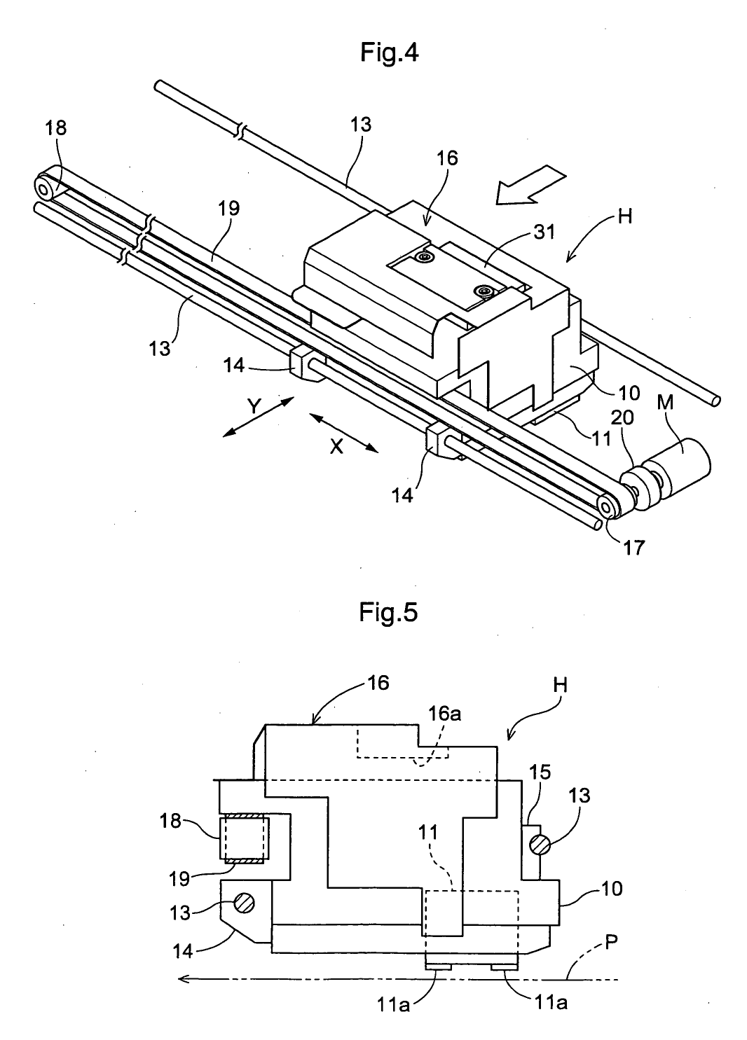

As shown in FIGS. 2-5, the print part B includes: a print head H configured to reciprocate in a main scanning direction X; and a suction unit 12 disposed on the opposite side of a delivery path of the printing paper P.

The print head H includes: a carriage 10; an ink discharge unit 11 connected to the carriage 10 and configured to discharge ink on the printing paper P for printing information; and a carriage cover 16 for covering the carriage 10 thereabove. The suction unit 12 in a shape of a case has an electric fan (not shown) therein, configured to suck air from a number of openings formed in an upper face of the unit and downward vent the air out.

The cutting part C has a delivery roller 21 for advancing the printing paper P in a pressure bonding state; a disc cutter 22 for cutting the printing paper P; and an operative mechanism 23 for reciprocating the disc cutter 22 in the main scanning direction X.

The backside print part D has a print head 24 for printing information on a backside of the printing paper P. The decurl part E includes: a delivery roller 25, a correction roller 26 opposed to the delivery roller 25, and a guide plate 27, which are arranged in such a manner that the printing paper P is advanced while curved in an opposite direction to a rolling direction of the roll of the printing paper RP, so as to correct curling propensity of the printing paper P. Though not shown in the drawings, the decurl part E has an electric motor for driving the delivery roller 25, and corrects curling propensity of the printing paper P by pressure bonding between the delivery roller 25 and the correction roller 26, during delivery of the printing paper P.

In the ink reservoir G, a plurality of ink cartridges (not shown) are set, and ink sent from the ink reservoir G is supplied to the print head H, through an intermediate tank (not shown) and a flexible tube.

### <Printing Process>

When printing is performed with this printing device, first an end of the printing paper P is sent under the print part B by the delivery mechanism A and then the feeding is paused. In this state, a negative pressure by the suction unit 12 affects on the backside of the printing paper P, to thereby suck the printing paper P on an upper face of the suction unit 12 and maintain the printing paper P in a flat state. Under this condition, while the print head H is reciprocating in the main scanning direction X, the ink discharge unit 11 discharges ink onto the printing paper P to thereby print information.

Specifically, printing is performed by discharging ink from the ink discharge unit 11 while the print head H is moving in one main scanning direction X, and when the print head H reached the moving end, the printing paper P is advanced in a sub-scanning direction Y by a predetermined amount by the delivery mechanism A. After this delivery, further printing of information is performed onto the printing paper P, by discharging ink from the ink discharge unit 11 while the print head H is moving in another main scanning direction X (in an opposite direction).

It should be noted that the term “moving end” herein means that a position where the print head H is stopped after the discharge of ink by the print head H is terminated. For example, in the case where the printing region changes, such as the case where multiple images are printed on the printing paper P, the position of the moving end changes. It should be noted that the timing of the delivery of the printing paper P in the sub-scanning direction Y is not limited to after the stopping of the movement of the print head H, but may be before the stopping of the movement of the print head H, as long as it is after the discharge of the ink by the print head H.

When the printing paper P on which information is printed by the reciprocating operation of the print head H is advanced to the cutting part C, and a portion of the printing paper P to be cut reaches a cutting position of the disc cutter 22, the delivery is stopped. During this resting state, the operative mechanism 23 moves the disc cutter 22 in the main scanning direction X to thereby cut the printing paper P into an appropriate print size.

Next, on the thus cut printing paper P, information or the like for specifying order is printed by the print head 24 of the backside print part D. Further, the printing paper P is sent to the delivery roller 25, the correction roller 26, and the guide plate 27 of the decurl part E where curl is corrected, and then ejected on an upper face of the paper catch tray 2.

In this printing device, the print head H is moved at a relatively high speed, and immediately after the stopping of this print head H at the moving end, the print head H is moved in an opposite direction to start printing, even before the vibration of the print head H attenuates. Accordingly, the printing device is provided with a structure for suppressing vibration of the print head H, which will be described below together with the configuration of the print part B.

### <Detail of Print Part>

In the print part B, a pair of guide rods 13 each having a circular cross section are parallelly disposed in the main scanning direction X. By the pair of the guide rods 13, the carriage 10 is slidably supported, and to a lower side of the carriage 10, the ink discharge unit 11 is connected. On a lower face of the ink discharge unit 11, ink discharge faces 11a are provided at two positions apart in the sub-scanning direction Y, each with a number of discharge holes formed therein for discharging ink.

On one side of the carriage 10 in the sub-scanning direction Y, a pair of slide guides 14 are provided, each having a circular hole configured to fit onto the guide rod 13. On the other side, there is provided a slide block 15 having a recess portion formed therein configured to engage with the other guide rod 13. The carriage 10 also has the carriage cover 16 on the top thereof.

A timing-belt type driving belt 19 wound around a driving pulley 17 and an idle pulley 18 is disposed in the main scanning direction X on a side of the carriage 10. The driving belt 19 and the carriage 10 are connected and a rotary driving force is transmitted from a driving motor M to the driving pulley 17. The driving pulley 17 has a rotary type encoder 20 configured to determine the position of the print head H in the main scanning direction X, based on a rotation amount. It should be noted that, in this printing device, in order to determine the position of the print head H in the main scanning direction X, there may be used a linear-type encoder which is disposed along the print head H.

In this manner, the driving pulley 17, the idle pulley 18, the driving belt 19 and the driving motor M form a means for moving the print head H.

The control unit F is configured to obtain information, such as images and letters to be printed, to control the delivery mechanism A, to control the driving motor M in accordance with a feedback signal from the encoder 20, and to control a driving mechanism in the ink discharge unit 11 by synchronizing with the driving of the driving motor M, to thereby discharge ink from the discharge holes of the ink discharge face 11a for printing information. In addition, this control unit F is configured to control the operative mechanism 23 of the cutting part C, to control the print head 24 of the backside print part D, and to control the decurl part E.

### <Weight>

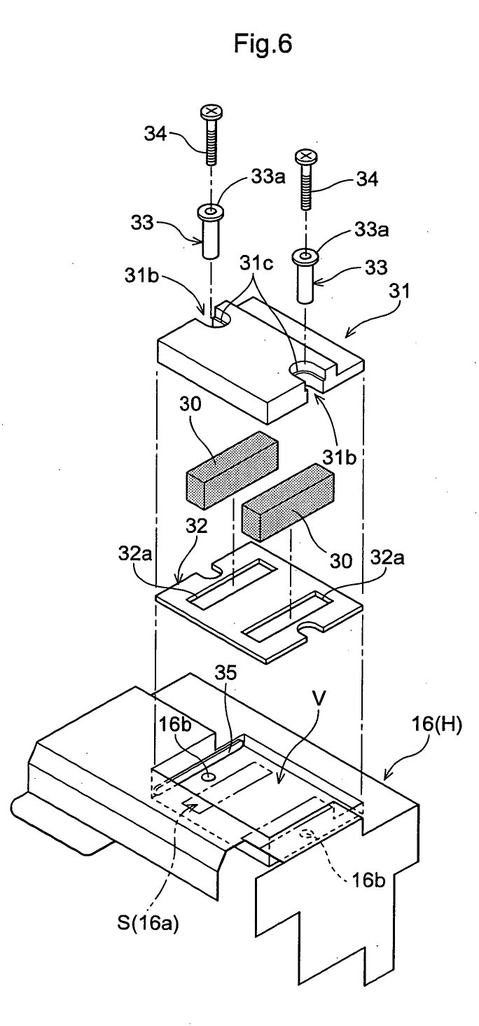

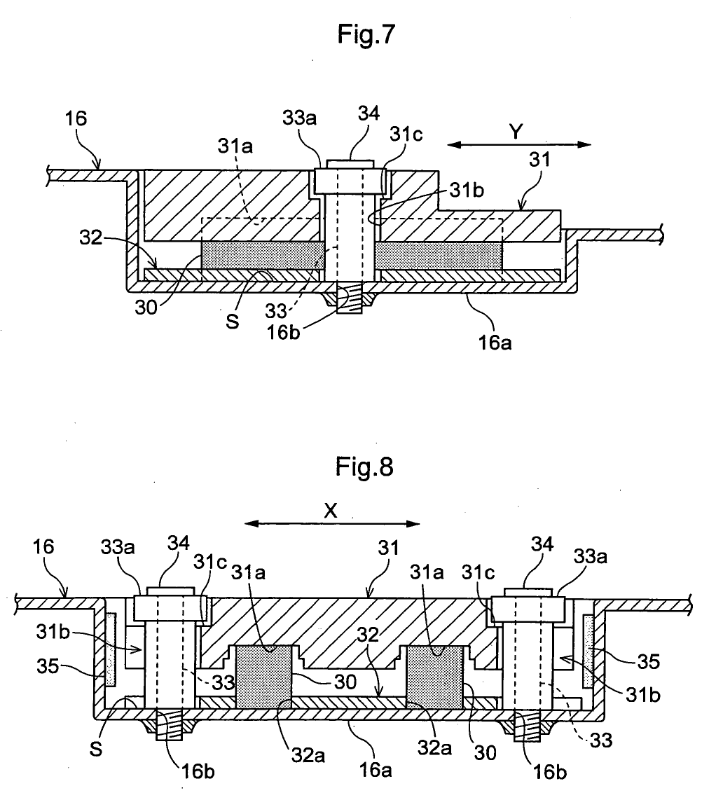

As shown in FIGS. 6-8, in this printing device, the weight 31 made of metal such as brass is supported by a support face S formed in the carriage cover 16, via a pair of shock absorbers 30, to thereby suppress vibration of the print head H. The shock absorber 30 is in a form of a rod having a rectangular cross section, and is supported by the support face S in such a manner that the longitudinal direction of the shock absorber 30 is oriented in the sub-scanning direction Y.

The shock absorber 30 absorbs impact by easily deforming itself when an external force is applied, and restores its shape when the external force is removed, and examples include a gel material mainly composed of silicone, and viscoelasticity polymer.

Specifically, in the carriage cover 16, a recess portion V is formed, and to a bottom wall 16a of the recess portion V, a plate 32 is attached. In the plate 32, a pair of openings 32a are formed, into which the shock absorbers 30 are inserted. In each of the end portions of the bottom wall 16a in the main scanning direction X, a screw hole 16b is formed. In addition, a pair of recess grooves 31a are formed in a bottom face of the weight 31, into which the shock absorbers 30 are fitted. In each of the end portions of the weight 31 in the main scanning direction X, a cut-out portion 31b is formed, and in an inner face of the cut-out portion 31b, a step-like portion 31c is formed.

According to this structure, the shock absorbers 30 are set on the support face S of the carriage cover 16 while fitting the shock absorbers 30 into the openings 32a of the plate 32, and the weight 31 is set on the upper faces of the shock absorbers 30 while fitting the shock absorbers 30 into the recess grooves 31a formed in the lower face of the weight 31. In addition, a bush 33 is fitted to the cut-out portion 31b, and a screw 34 penetrating the bush 33 is engaged with the screw hole 16b, to thereby fix the bush 33.

It is preferable that the lower face of the shock absorber 30 is adhered to the support face S, and the upper face of the shock absorber 30 is adhered to the recess groove 31a of the weight 31. However, since the surface of the shock absorber 30 has tackiness, it would be sufficient for retaining a relative positional relationship between the carriage cover 16 and the weight 31, to simply bring the lower face of the shock absorber 30 into contact with the support face S, and the upper face of the shock absorber 30 into contact with the recess groove 31a of the weight 31.

On an upper end of the bush 33, a flange portion 33a is integrally formed, and when the bush 33 is fixed to the carriage cover 16, a positional relationship is retained in which the bush 33, including the outer circumference and the flange portion 33a thereof, is not brought into contact with the inner face of the cut-out portion 31b and the step-like portion 31c of the weight 31. With this positional relationship, the weight 31 is not completely interfered by the bush 33, but can be displaced in the main scanning direction X to some extent.

The bush 33 is one example of the elevation suppressing member for suppressing elevation of the weight 31, and it prevents the weight 31 from detaching from the carriage cover 16 by bringing the flange portion 33a of the bush 33 into contact with the step-like portion 31c, when the weight acts in such a direction that the weight 31 is separated from the carriage cover 16, such as when the whole printing device is tilted to a large degree.

Among side walls of the recess portion V of the carriage cover 16, each side wall orthogonal to the main scanning direction X (position facing the weight 31 in the main scanning direction X) has a plate-shaped regulator 35 made of a rubber material, sponge material or the like attached thereto, which is configured to determine a displacement limit of the weight 31. When the weight 31 is displaced to a large degree in the main scanning direction X, such as by an external force acting on the printing device, the regulator 35 prevents the weight 31 and shock absorber 30 from being damaged, by coming into contact with the weight 31. Especially, in the case where the shock absorber 30 deteriorates after a long-term use, or in the case where the weight 31 is displaced in the main scanning direction X to a larger degree than the designed value due to individual specificity of the shock absorber 30, the displacement of the weight 31 is regulated by bringing the regulator 35 into contact with the weight 31.

In the present invention, the print head H may include members other than the carriage 10, the ink discharge unit 11 and the carriage cover 16. Further, the support face S may be formed in any of the members forming the print head H, to support the weight 31 through the shock absorber 30. The support face S is not limited to be formed in the upper face of the member forming the print head H, and may be formed in a side face or lower face thereof. Especially, the support face S may be formed inside the member forming the print head H, to support the weight 31 through the shock absorber 30.

### <Suppression of Vibration>

As described above, the carriage 10 is slidably supported through the slide guides 14 fitted onto one of the pair of the guide rods 13, and the slide block 15 engaging with the other guide rod 13. With this support structure, the carriage 10 is incapable of vertically moving on a side where there are the slide guides 14, while capable of vertically moving (though to a small degree) on a side where the slide block 15 is disposed.

In this manner, since the carriage 10 is allowed to vertically move at the end position in the sub-scanning direction Y, when the carriage 10 moving at a high speed is stopped and restarted to move at a high speed in an opposite direction, kinetic energy acts on the carriage 10 and vibration may be generated that vertically displaces the end position of the carriage 10 in the sub-scanning direction Y. The shock absorber 30 and the weight 31 serve for suppressing such vibration.

In other words, when the print head H moving in the main scanning direction X is stopped and kinetic energy of the carriage 10 and print head H acts in a direction that may otherwise generate vertical vibration of the print head H, the shock absorber 30 flexibly deforms, and thus the weight 31 can be displaced in the main scanning direction X due to dynamic inertia. In addition, the gravity of the weight 31 holds down the print head H. As a result, kinetic energy of the weight 31 never acts in a direction that generates vibration. Moreover, since the weight 31 is allowed to be displaced in the main scanning direction X, vibration of the print head H is suppressed by the gravity of the weight 31.

Likewise, when the print head H in a resting state is started to move at a high speed and kinetic energy acts in a direction that may otherwise generate vertical vibration of the print head H, static inertia, or remaining dynamic inertia caused immediately before the stopping of the print head H, acts on the weight 31. Therefore, the shock absorber 30 flexibly deforms, and thus the weight 31 is displaced in the main scanning direction X with a delay. In addition, since the gravity of the weight 31 holds down the print head H, vibration of the print head H is suppressed.

It should be noted that, instead of the bush 33, for example a cover disposed above the entire weight 31 may be provided as the elevation suppressing member, in such a manner that an upward displacement of the weight 31 is suppressed.

Also in the present invention, the shock absorber 30 in a shape of a sheet may be set on the support face S formed in the print head H, and the weight 31 may be set thereon.

### Second Embodiment

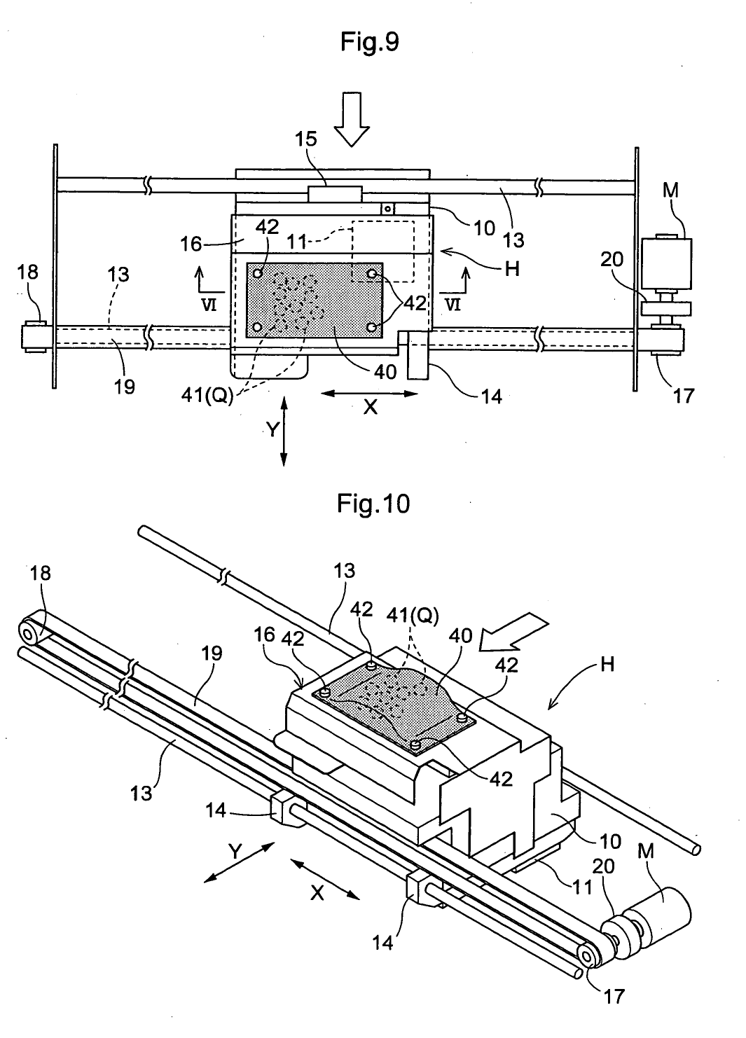

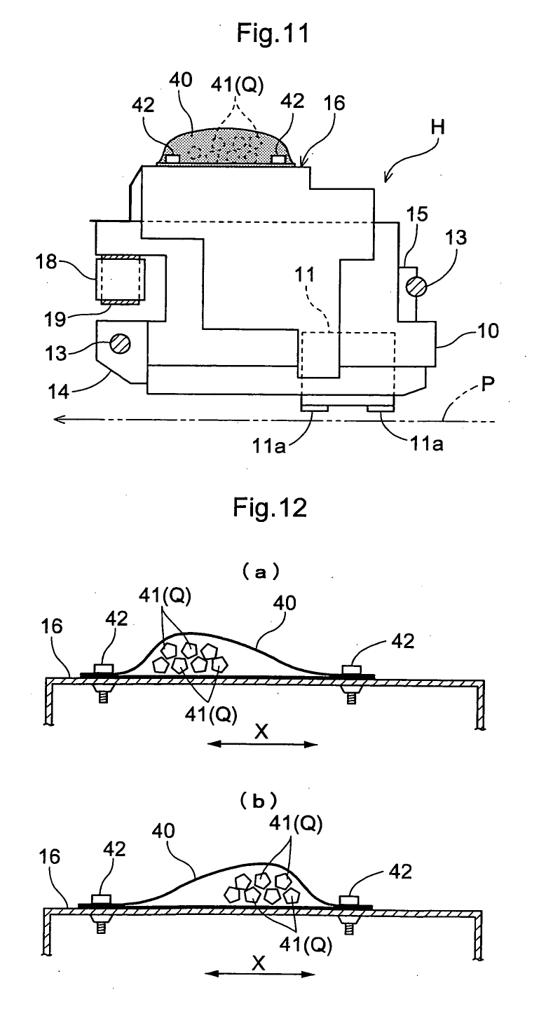

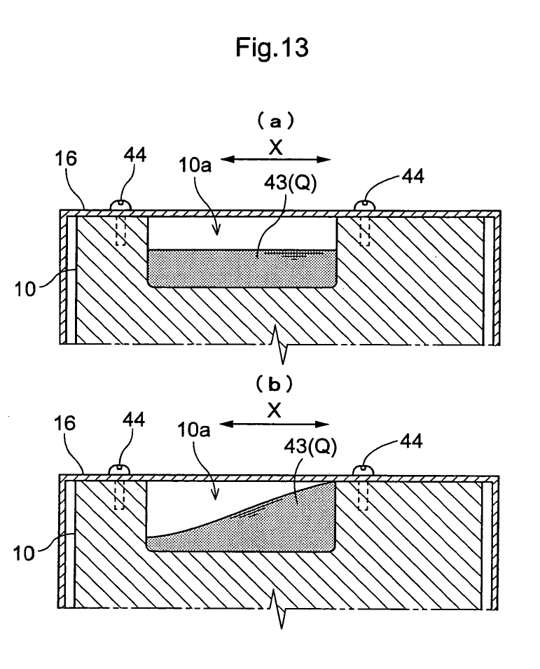

Hereinbelow, another embodiment of the present invention will be described with reference to the drawings. Since the overall structure, the printing process and the details of the print part are the same as those of the first embodiment, detailed descriptions are omitted. However, it should be noted that FIGS. 3, 4 and 5 in the description of the first embodiment should be replaced with FIGS. 9, 10 and 11, respectively.

### <Vibration Suppressor>

As shown in FIGS. 9-12B, in this printing device, on the upper face of the carriage cover 16, there is provided a bag member 40 made of a flexible material, such as fabric and resin sheet, in which granules of metal pieces 41 as an example of a vibration suppressor Q are sealed, for the purpose of suppressing vibration of the print head H.

The vibration suppressor Q requires to have a certain weight, since vibration of the print head H is suppressed by applying a force or a weight onto the print head H, the former being caused in the vibration suppressor Q by dynamic inertia along a movement of the print head H or static inertia, and the latter is of the vibration suppressor Q itself. For this reason, the metal piece 41 is selected as the vibration suppressor Q.

The bag member 40 is configured to have a sufficient volume to allow the metal pieces 41 to be freely displaced, and is supported to the print head H by fixing the end portions in the main scanning direction X to the carriage cover 16 with screws 42. The metal pieces 41 are sealed in the bag member 40 with a sufficient space left to allow the metal piece 41 to move inside.

In order to suppress vibration, it is desirable that the metal piece 41 be relatively heavy and have a polyhedron structure, rather than a smooth round shape that rolls over like a ball, since a piece with a polyhedron structure moves with some frictional force acting on the print head H in the main scanning direction X and the sub-scanning direction Y during the operation of the print head H, which is effective for suppressing vibration.

In the present invention, the print head H may include members other than the carriage 10, the ink discharge unit 11 and the carriage cover 16. The bag member 40 may be provided on any of a side face, a bottom face and the like of a member forming the print head H, in which the vibration suppressor Q, such as the metal pieces 41, is sealed.

Especially, a member forming the print head H may have a container space therein, in which the vibration suppressor Q, such as the metal pieces 41, is sealed. In this case, the container space formed in the print head H should have a larger volume than a total volume of the metal pieces 41, with a sufficient space left to allow the metal piece 41 to move inside in the main scanning direction X.

### <Modified Version of Vibration Suppressor>

In the present invention, as the vibration suppressor Q, a fluid body 43 (vibration suppressor fluid) may be used, such as oil, emulsion and slurry, which has a relatively high viscosity. Specifically, as shown in FIG. 13A, a recess portion 10a is formed in an upper face of the carriage 10, and the carriage cover 16 is fixed with screws 44 so as to cover the recess portion 10a and to seal the fluid body 43 in the print head H. In this case, the space should have a larger volume than a volume of the fluid body 43 to be sealed so that the fluid body 43 is allowed to move in the main scanning direction X.

Alternatively, as a space formed in the print head H, a cylindrical hole having an axis in parallel with the main scanning direction X may be formed in a member forming the print head H, in which the vibration suppressor Q is sealed with ends of the hole closed with plugs or the like. Alternatively, a cylindrical member having a space formed therein may be provided to the print head H.

In this modified version also, for example, a bag member made of a flexible material, such as fabric and resin sheet, may be fixed to the carriage 10 or the carriage cover 16, and the fluid body 43 may be sealed in the bag member. Especially in the present invention, the bag member may be provided on any of a side face, a bottom face and the like of a member forming the print head H, in which the fluid body 43 is sealed.

### <Suppression of Vibration>

As described above, the carriage 10 is slidably supported by the slide guides 14 fitted onto one of the pair of the guide rods 13, and the slide block 15 engaging with the other guide rod 13. With this support structure, the carriage 10 is incapable of vertically moving on a side where there are the slide guides 14, while capable of vertically moving (though to a small degree) on a side where the slide block 15 is disposed.

In this manner, since the carriage 10 is allowed to vertically move at the end position in the sub-scanning direction Y, when the carriage 10 moving at a high speed is stopped and restarted to move at a high speed in an opposite direction, kinetic energy acts on the carriage 10, and vibration may be generated in a direction with a low rigidity, which in turn generates vibration that vertically displaces the end portion of the carriage 10 in the sub-scanning direction Y. The vibration suppressor Q serves for suppressing such vibration.

In other words, when the print head H moving in the main scanning direction X is stopped and kinetic energy of the carriage 10 and print head H acts in a direction that may otherwise generate vertical vibration of the print head H, the vibration suppressor Q can be displaced in the main scanning direction X due to dynamic inertia. In addition, the weight of the vibration suppressor Q holds down the print head H. Specifically, every time the print head H reaches the moving end, the metal pieces 41 as the vibration suppressor Q move in one of the main scanning directions X, and thus they move between the states shown in FIG. 12A and one shown in FIG. 12B, and as a result, the print head H is held down.

It should be noted that, in the case where the fluid body 43 is used as the vibration suppressor Q, the fluid body 43 as the vibration suppressor Q moves in one of the main scanning directions X, and the state thereof changes, for example, from one shown in FIG. 13A to one shown in FIG. 13B, and as a result, the print head H is held down.

Therefore, kinetic energy of the vibration suppressor Q never acts in a direction that generates vibration. Moreover, since the vibration suppressor Q is allowed to be displaced in the main scanning direction X, vibration of the print head H is suppressed by the weight of the vibration suppressor Q.

Likewise, when the print head H in a resting state is started to move at a high speed and kinetic energy acts in a direction that may otherwise generate vertical vibration of the print head H, static inertia, or remaining dynamic inertia caused immediately before the stopping of the print head H (dynamic inertia in the main scanning direction X), acts on the vibration suppressor Q, by which the vibration suppressor Q is displaced in the main scanning direction X with a delay. In addition, since the weight of the vibration suppressor Q holds down the print head H, vibration of the print head H is suppressed.

Accordingly, with respect to the printing device in which the print head H performs printing of information by discharging ink while moved at a high speed, and, when the print head H reached the moving end, the moving direction is switched to restart to move the print head H at a high speed even before the vibration of the print head H attenuates, there can be performed printing with high quality, by suppressing vibration of the print head H which may otherwise be generated at the moment of switching the direction. The present invention can be applicable to a printing device with a printing configuration in which ink is discharged only when the print head H moves in one direction (e.g., from left to right).

Especially in the present invention, the carriage 10, the ink discharge unit 11 and the carriage cover 16 are described as separate members. However, they may be integrally formed as a single print head H, configured to be directly supported by the guide rod 13.

What is claimed is:

1. A printing device comprising:
a print head configured to discharge ink onto a recording medium while moving in a main scanning direction, which comprises:
a support face;
a shock absorber; and
a weight supported by the support face through the shock absorber.

2. The printing device according to claim 1, wherein the print head further comprises an elevation suppressing member configured to suppress elevation of the weight while allowing a displacement of the weight in the main scanning direction on the support face.

3. The printing device according to claim 2, wherein the print head further comprises a regulator which faces the weight in the main scanning direction and is configured to determine a displacement limit of the weight in the main scanning direction on the support face.

4. The printing device according to claim 1, wherein the shock absorber comprises a plurality of rods which are set on the support face with a longitudinal direction of the rod being oriented in a sub-scanning direction orthogonal to the main scanning direction.

5. A printing device comprising:
a print head configured to discharge ink onto a recording medium while moving in a main scanning direction, which comprises:
a vibration suppressor which is provided to the print head movably in the main scanning direction, and is configured to suppress vibration of the print head caused along with the movement of the print head.

6. The printing device according to claim 5, wherein the vibration suppressor is contained in one of a flexible bag member disposed on the print head and a space formed in the print head.

7. The printing device according to claim 6, wherein the vibration suppressor is formed of one of a granular body and a fluid body having a high viscosity.
